(19) United States
(12) Patent Application Publication
(10) Pub. No.: US 2010/0269265 A1
(43) Pub. Date: Oct. 28, 2010

(54) Method

(75) Inventor: Marielle De La Torre, Antibes (FR)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt & Colman (Overseas) Limited

(21) Appl. No.: 12/594,642

(22) PCT Filed: Mar. 7, 2008
(86) PCT No.: PCT/GB08/00792

§ 371 Date: Jun. 28, 2010

(30) Foreign Application Priority Data
Apr. 10, 2007 (GB) 0706833.1

(51) Int. Cl. C11D 3/00; C11D 3/40

(52) U.S. Cl. 8/137

(57) ABSTRACT

A method of treating a textile, the textile carrying a stain. The method comprises the following steps: (i) applying a liquid detergent composition in the form of a foam to a textile, the liquid detergent composition comprises a time dependent fading chromophore, and carriers and adjuncts to 100%; (ii) waiting until the foam, as applied, has changed colour from its originally applied colour; (iii) rinsing the portion of the textile to which the foam has been applied with water; and, (iv) drying the textile.

The present invention provides a method of treating a textile with a composition wherein the composition comprises a time dependent fading chromophore.

It is known to use dyes in detergent powders. The dyes used impart a colour both to the detergent composition and an aqueous wash medium to which the detergent composition added. The dye used maintains its integrity in the detergent composition as formulated and is unaffected upon addition to an aqueous medium. Therefore the dye provides no cue to the consumer as to the progress of the washing operation.

The present invention provides a method of treating a textile, the textile carrying a stain, the method comprising the following steps: (i) applying a liquid detergent composition in the form of a foam to a textile, the liquid detergent composition comprising a time dependent fading chromophore, and carriers and adjuncts to 100%; (ii) waiting until the foam, as applied, has changed colour from its originally applied colour; (iii) rinsing the portion of the textile to which the foam has been applied with water; and, (iv) drying the textile.

The present invention provides an alternative method of treating a textile, the textile carrying a stain, the method comprising the following steps: (i) applying a liquid detergent composition in the form of a foam to a textile, the liquid detergent composition comprising a time dependent fading chromophore, and carriers and adjuncts to 100%; (ii) waiting until the foam, as applied, has changed colour from its originally applied colour; (iii) washing the whole textile to which the foam has been applied with usual fabric detergents; (iv) rinsing the textile with water; and, (v) drying the textile.

The colour cue of the present invention is provided by a time dependent fading chromophore; the colour of the chromophore is dependent upon the time in which it is exposed to its environment (washing environment). Preferably the time dependent fading chromophore fades within a few minutes, e.g. within 10 minutes of exposure to the washing environment.

The method may include the step of dissolving a detergent concentrate in water to provide the liquid detergent composition for application. This detergent concentrate may be selected from the group consisting of: liquid and granular solid detergent concentrates.

The colour change indicates that the textile has been treated for sufficient time. An initial colour also provides improved stain to treatment registration such that an environmental benefit is obtained because less detergent is used in cleaning a stain.

The time dependent fading chromophore is preferably chosen from the group comprising triphenylmethane dyes having a hydrogen group in ortho position on one or more of the phenyl rings attached to the central carbon; indigoid dyes such as potassium indigo trisulfonate and potassium indigo tetrasulfonate; acid fuschin, aniline blue, light green SF yellowish, Lissamine Green B and Methyl green.

A mixture of chromophores may be used in the present invention.

The amount of the chromophore present in the composition will vary depending on the extinction coefficient/colour intensity of the indicator required. The amount of chromophore required is that sufficient for a discernable change in colour to be observable by the human eye. Suitably, the chromophore, or mixtures thereof, are present in the detergent composition in the range 0.0001 to 0.5 wt %, preferably 0.001 to 0.4 wt %, most preferably 0.002 to 0.3 wt %.

The present invention is used as a liquid format where the composition is dispensed as foam and the dispensed product interacts with the environment. Foam has a high surface area to volume ratio and rapidly absorbs air from the atmosphere. The bulk within the foam dispenser may or may not be in contact with atmospheric gasses. Nevertheless, it is preferred that the internal gaseous environment does not readily exchange with the external gaseous environment when the dispenser is not in use.

Anionic Surfactant, Non-ionic surfactant and Amphoteric Surfactants or mixtures thereof may be used in this foam aspect of the present invention. Examples of suitable surfactants systems that may be used for the foam are as follows: sodium lauryl alkyl sulphate (LAS), sodium lauryl ether sulphate (SLES) and coco amidopropyl betaine (CAPB); sodium lauryl alkyl sulphate (LAS) non-ionic (NI) and coco amidopropyl betaine (CAPB); primary alcohol sulphate (PAS), sodium lauryl ether sulphate (SLES) and coco amidopropyl betaine (CAPE); primary alcohol sulphate (PAS), sodium lauryl ether sulphate (SLES) and non-ionic (NI); and sodium lauryl alkyl sulphate (LAS) and non-ionic (NI).

The composition preferably comprises a surfactant and optionally other conventional detergent ingredients. It is preferred that the composition used to make the foam comprises 0.001% wt/wt to 20% wt/wt of a detergent(s). It is most preferred that the detergent composition is alkaline. The alkalinity may be provided by, for example, sodium hydroxide, sodium carbonate, sodium silicate, an amine, sodium tripolyphosphate (STP) and/or zeolite. This alkalinity is preferably provided for by sodium carbonate and/or sodium hydroxide. The invention in its second aspect provides an enzymatic detergent composition which comprises from 0.1-50% by weight, based on the total detergent composition, of one or more surfactants. This surfactant system may in turn comprise 0-95% by weight of one or more anionic surfactants and 5 to 100% by weight of one or more nonionic surfactants. The surfactant system may additionally contain amphoteric or zwitterionic detergent compounds, but this in not normally desired owing to their relatively high cost. The enzymatic detergent composition according to the invention will generally be used as a dilution in water of about 0.05 to 2%.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenolethylene oxide condensates, generally 5 to 25 EO, i.e. 5 to 25 units of ethylene oxide per molecule, and the condensation products of aliphatic C₈-C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals.

Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁-C₁₅ alkyl benzene sulphonates and sodium C₁₂-C₁₈ alkyl sulphates.

Preferred surfactant systems are mixtures of anionic with nonionic detergent active materials. Especially preferred is surfactant system that is a mixture of an alkali metal salt of a C₁₂-C₁₈ primary alcohol sulphate together with a C₁₂-C₁₅ primary alcohol 3-7 EO ethoxylate.

The nonionic detergent is preferably present in amounts greater than 10%, e.g. 25-90% by weight of the surfactant system. Anionic surfactants can be present for example in amounts in the range from about 5% to about 40% by weight of the surfactant system.

The detergent composition may take any suitable physical form, such as a powder, granular composition, tablets, a paste or an anhydrous gel.

The present invention may be used in combination with bleaching species. These species may be, for example a peroxygen bleach species alone and/or in combination with a bleach activator and/or a transition metal catalyst; and a transition metal catalysts in a composition substantially devoid of peroxygen species.

Bleach activators are well known in the art, for example TAED, and SNOBS. Peroxygen bleaching agents are also well known in the art, for example, peracids (e.g., PAP), perborates, percarbonates, peroxyhydrates, and mixtures thereof. Specific preferred examples include: sodium perborate, commercially available in the form of mono- and tetra-hydrates, and sodium carbonate peroxyhydrate.

Builders, polymers and other enzymes as optional ingredients may also be present in the detergent composition.

1. A method of treating a textile, the textile carrying a stain, the method comprising the following steps:
(i) applying a liquid detergent composition in the form of a foam to a textile, the liquid detergent composition comprising a time dependent fading chromophore, and carriers and adjuncts to 100 wt. %;
(ii) waiting until the foam, as applied, has changed colour from its originally applied colour;
(iii) rinsing the portion of the textile to which the foam has been applied with water; and,
(iv) drying the textile.

2. A method of treating a textile according to claim 1, wherein the time dependent fading dependent chromophore is selected from the group consisting of: triphenylmethane dyes having a hydrogen group in ortho position on one or more of the phenyl rings attached to the central carbon;
indigoid dyes such as potassium indigo trisulfonate and potassium indigo tetrasulfonate;
acid fuschin;
aniline blue;
light green SF yellowish;
Lissamine Green B; and,
Methyl green.

3. A method of treating a textile according to claim 1, wherein the pH dependent chromophore is present in the composition in the range 0.0001 to 0.5 wt %.

4. A method of treating a textile according to claim 1, wherein the method comprises the step of:
dissolving a detergent concentrate in water to provide the liquid detergent composition for application of the liquid detergent composition in the form of a foam.

5. A method of treating a textile according to claim 4, wherein the detergent concentrate is selected from the group consisting of: liquid and granular solid detergent concentrates.

6. A method of treating a textile according to claim 6 wherein the indigoid dyes are selected form potassium indigo trisulfonate and potassium indigo tetrasulfonate, and mixtures thereof.

7. A method of treating a textile according to claim 3, wherein the pH dependent chromophore is present in the composition in the range 0.001 to 0.4 wt %.

8. A method of treating a textile according to claim 7, wherein the pH dependent chromophore is present in the composition in the range 0.002 to 0.3 wt %.

9. A method of treating a textile, the textile carrying a stain, the method comprising the following steps:
(i) applying a liquid detergent composition in the form of a foam to a textile, the liquid detergent composition comprising a time dependent fading chromophore, and carriers and adjuncts to 100 wt. %;
(ii) waiting until the foam, as applied, has changed colour from its originally applied colour;
(iii) washing the whole textile to which the foam has been applied with a fabric detergent;
(iv) rinsing the textile to which the foam has been applied with water; and,
(iv) drying the textile.

10. A method of treating a textile according to claim 9, wherein the time dependent fading dependent chromophore is selected from the group consisting of: triphenylmethane dyes having a hydrogen group in ortho position on one or more of the phenyl rings attached to the central carbon;
indigoid dyes such as potassium indigo trisulfonate and potassium indigo tetrasulfonate;
acid fuschin;
aniline blue;
light green SF yellowish;
Lissamine Green B; and,
Methyl green.

11. A method of treating a textile according to claim 9, wherein the pH dependent chromophore is present in the composition in the range 0.0001 to 0.5 wt %.

12. A method of treating a textile according to claim 11, wherein the pH dependent chromophore is present in the composition in the range 0.001 to 0.4 wt %.

13. A method of treating a textile according to claim 12, wherein the pH dependent chromophore is present in the composition in the range 0.002 to 0.3 wt %.

14. A method of treating a textile according to claim 1 wherein the liquid detergent composition comprises one or more surfactants, and optionally further comprises one or more other conventional detergent ingredients.

15. A method of treating a textile according to claim 14, wherein the liquid detergent composition comprises a mixture of anionic and nonionic surfactants.

16. A method of treating a textile according to claim 1, wherein the liquid detergent composition comprises a bleaching species.

17. A method of treating a textile according to claim 9 wherein the liquid detergent composition comprises one or more surfactants, and optionally further comprises one or more other conventional detergent ingredients.

18. A method of treating a textile according to claim 17, wherein the liquid detergent composition comprises a mixture of anionic and nonionic surfactants.

19. A method of treating a textile according to claim 9, wherein the liquid detergent composition comprises a bleaching species.
